(19) United States
(12) Patent Application Publication
(10) Pub. No.: US 2008/0239965 A1
(43) Pub. Date: Oct. 2, 2008

(54) Method And System For Reporting Terminal Information, And Method And System For Maintaining Terminal Device, As Well As Device Management System

(76) Inventor: Jie Tang, Guangdong Province (CN)

Correspondence Address: OCCHIUTI ROHLICEK & TSAO, LLP, 10 FAWCETT STREET, CAMBRIDGE, MA, 02138, US

(21) Appl. No.: 10/590,923

(22) PCT Filed: Apr. 30, 2006
(86) PCT No.: PCT/CN2006/000884

§ 371 Date: Aug. 25, 2006

(30) Foreign Application Priority Data
May 19, 2005 (CN) 200510070959.3

(51) Int. Cl. G06F 11/00

(52) U.S. Cl. 370/241

(57) ABSTRACT

The invention discloses a method and a system of reporting terminal information in Device Management (DM) field. The method includes: the terminal reporting terminal information through an information reporting interface provided by a DM Agent module; the DM Agent module forwarding the terminal information to a DM Server; and the DM Server reporting the terminal information to a Maintenance Unit (MU) through a local information reporting interface. The invention also discloses a method and a system for maintaining terminal device in DM field as well as a DM system.

### FIELD OF THE INVENTION

The invention relates to communication technology field, especially to a method and a system for maintaining terminal device and a device management system.

### BACKGROUND OF THE INVENTION

Mobile terminals are important components of the entire mobile operation service system. As the functions of terminals become increasingly sophisticated, it is more likely that errors occur in terminal software. The competition among operators will be increasingly intense in the future; therefore, how to effectively maintain efficient Quality of Service (QoS) and low-cost device maintenance has become a major concern for operators and terminal manufacturers.

Device Management, as an important part in the Open Mobile Alliance (OMA) specifications, has specified some fundamental standard protocols for device management. However, it has not covered all aspects of device management. For example, with respect to the functionality of device fault resolution, in the existing OMA Device Management (DM) process, if an error occurs on a device, the user of the device has to notify the operator by some means (e.g., phone, WEB site, WAP site, etc.), then the operator's DM system initiates a resolution process to implement terminal configuration, as described hereunder:

1. The user reports the error to the customer service center for example, by means of a voice call;

2. The customer service center queries the device for device information;

3. The device reports its relevant configuration information including device type, device serial number, Operating System (OS) version, capability, list of installed applications, event/performance logs, etc. to the customer service center;

4. Based on this information, the person in the customer service center determines the causes of the error and requests the user for authorization to download the fault resolution software;

5. The user grants the authorization;

6. The customer service center pushes the application to the device; and the device installs and executes the application;

7. The device sends an acknowledgement message to the customer service center.

The above method requires the user to detect the error actively and notify the operator of the error before the fault resolution assistance may be provided. Such a method restricts the ways available for the operator to obtain errors in user terminals.

If the user has little knowledge of technical terms of the terminal, it is difficult for the user to report the terminal information accurately to the operator.

The terminal software developer has to handle software errors in a passive way; as a result, error detection and handling are often delayed.

### SUMMARY OF THE INVENTION

The present invention provides a method and a system of reporting terminal information and a method and a system for maintaining terminal device as well as a device management system.

The method of reporting terminal information includes the following steps:

reporting, by a terminal device, the information of the terminal through a software program interface provided by a Device Management (DM) Agent module;

forwarding, by the DM Agent module, the terminal information to a DM Server; the DM Server reporting the terminal information to a Maintenance Unit (MU).

the software program interface includes a messaging interface, a file interface, an API, or a Web service interface.

the messaging interface includes an XML interface or a network protocol interface.

When the software program interface employs the API, the terminal information is combined into an XML format and is transmitted to the API as an argument.

The DM Agent module transmits the terminal information via an extended Open Mobile Alliance (OMA) DM protocol.

The transmission of the terminal information by the DM Agent module is implemented with a command of the extend OMA DM protocol which supports active event triggered by clients; or

the transmission of the terminal information by the DM Agent module is implemented by extending a standard command of the OMA DM protocol into a terminal information reporting command; or

the transmission of the terminal information by the DM Agent module is implemented by adding a special terminal information reporting command into the OMA DM protocol; or

the transmission of the terminal information by the DM Agent module is implemented with a command of the OMA DM protocol directly.

The terminal information includes error information created during the operation of the terminal software, error information created by the terminal hardware, and process information created during the operation of the terminal.

The method for maintaining terminal device includes the following steps:

reporting, by the terminal device, the information of the terminal through a software program interface provided by a Device Management (DM) Agent module;

forwarding, by the DM Agent module, the terminal information to a DM Server;

reporting, by the DM Server, the terminal information to a Maintenance Unit (MU);

when receiving the terminal information, determining, by the MU, the corresponding software update package and sending the software update package to the DM Server;

maintaining, by the DM Server, the terminal device with the software update package following an OMA DM process.

Before the step of reporting by the DM Server the terminal information to a Maintenance Unit (MU), the method further including: upon receiving the terminal information, judging, by the DM Server, whether the terminal device may be maintained automatically; if the judgment is “Yes”, maintaining, by the DM server, the terminal device directly following the OMA DM process; otherwise the method proceeds to the step of the DM Server reporting the terminal information to a Maintenance Unit (MU) and the subsequent steps of the reporting step.

The software program interface includes a network protocol interface, an XML interface, or an API.

When the software program interface employs the API, the terminal device program will combine the terminal information into an XML format and send the terminal information to the API as an argument.

The DM Agent module transmits the terminal information via an extended OMA DM protocol.

The transmission of the terminal information by the DM Agent module is implemented with commands supporting active event triggered by clients in the extend OMA DM protocol; or the transmission of the terminal information by the DM Agent module is implemented by extending a standard command of OMA DM protocol into a terminal information reporting command; or

the transmission of the terminal information by the DM Agent module is implemented by adding a special terminal information reporting command into the OMA DM protocol; or the transmission of the terminal information by the DM Agent module is implemented with a command of the OMA DM protocol directly.

The terminal information includes error information created during operation of the terminal software, error information created by terminal hardware, and process information created during operation of the terminal.

The Device Management (DM) system includes a DM Server adapted to manage a terminal device, a DM Agent module located in the terminal device and interacting with the DM Server, and a Maintenance Unit (MU) coupled to the DM Server and adapted to acquire, store, and maintain the information of the terminal device;

The DM Agent modules and the DM Server have a software program interface respectively;

The software program interface of the DM Agent module is adapted to receive the terminal information reported from the terminal devices and forward the terminal information to the DM Server; the DM Server reports the terminal information to the MU.

The software program interface is a messaging interface, a file interface, an API, or a Web service interface. With the software program interfaces provided by the DM Agent module and the DM Server for information reporting, the terminal device software may report terminal information to the DM module, and enables the DM Agent module to automatically report the terminal information in an extended protocol to the DM Server, which in turn reports the terminal information to the MU, so that the terminal software developer may obtain the terminal information from the terminal software timely and accurately and thereby perform maintenance as appropriate. The invention may enhance the automatic fault resolution capability of the terminal software and simplify the DM fault resolution process, providing ease for user operation and management.

The system for reporting terminal information applied to a communication network includes: a first terminal configured to communicate with a second terminal accessing the communication network; a management unit arranged in the first terminal, configured to receive the information of the first terminal reported by the first terminal; and a management server, configured to receive the information sent by the management unit;

wherein the information of the first terminal is reported to the management unit via a software program interface; the software program interface is a messaging interface, a file interface, an API, or a Web service interface;

wherein the messaging interface is an XML interface or a network protocol interface;

wherein when the software program interface is the API, the information of the first terminal is combined into an XML format and is reported to the API as an argument;

wherein the management unit sends the information of the first terminal to the management server via an extended Open Mobile Alliance DM (OMA DM) protocol;

wherein the management unit sends the information of the first terminal to the management server with a command of the extend OMA DM protocol which supports active event triggered by clients; or

the management unit sends the information of the first terminal to the management server by extending a standard command of the OMA DM protocol into a terminal information reporting command; or

the management unit sends the information of the first terminal to the management server by adding a special terminal information reporting command into the OMA DM protocol; or

the management unit sends the information of the first terminal to the management server with a command of the OMA DM protocol directly.

The system for maintaining terminal device applied to a communication network includes: a first terminal configured to communicate with a second terminal accessing the communication network; a management unit arranged in the first terminal, configured to receive the error information of the first terminal; a management server, configured to receive the error information sent by the management unit; and a maintenance unit, configured to receive the error information of the first terminal sent by the management server and send a corresponding software update package for maintaining the first terminal to the management server;

wherein the management server maintains the first terminal with the corresponding software update package following an OMA DM process;

wherein upon receiving the error information of the first terminal, the management server judges whether the first terminal can be maintained automatically; if the judgment is “Yes”, the management server maintains the first terminal directly following the OMA DM process; otherwise, the management server sends the error information of the first terminal to the maintenance unit.

The method of reporting terminal information applied to a communication network includes: reporting, by a terminal accessing the communication network, the information of the terminal to a management unit; upon receiving the information of the terminal, the management unit sending the information to a management server;

wherein the information of the terminal is reported to the management unit via a software program interface; the software program interface is a messaging interface, a file interface, an API, or a Web service interface;

wherein the messaging interface is an XML interface or a network protocol interface;

wherein when the software program interface is the API, the terminal information is combined into an XML format and is reported to the API as an argument;

wherein the management unit sends the information of the terminal to the management server via an extended Open Mobile Alliance DM (OMA DM) protocol;

wherein the management unit sends the information of the terminal to the management server with a command of the extend OMA DM protocol which supports active event triggered by clients; or

the management unit sends the information of the terminal to the management server by extending a standard command of the OMA DM protocol into a terminal information reporting command; or

the management unit sends the information of the terminal to the management server by adding a special terminal information reporting command into the OMA DM protocol; or

the management unit sends the information of the terminal to the management server with a command of the OMA DM protocol directly.

The method for maintaining terminal device applied to a communication network includes: sending, by a terminal accessing the communication network, the information of the terminal to a management unit; upon receiving the information of the terminal, the management unit sending the information to a management server; upon receiving the information of the terminal, the management server a corresponding software update package for maintaining the first terminal to the management server;

wherein the management server maintains the terminal with the corresponding software update package following an OMA DM process;

wherein upon receiving the error information of the first terminal, the management server judges whether the first terminal can be maintained automatically; if the judgment is “Yes”, the management server maintains the first terminal directly following the OMA DM process; otherwise, the management server reports the error information of the first terminal to the maintenance unit.

### BRIEF DESCRIPTION OF THE DRAWINGS

FIG. 1 is a schematic of the DM system architecture according to an embodiment of the present invention;

FIG. 2 is a flow chart of reporting terminal information from the terminal device according to an embodiment of the present invention;

FIG. 3 is a flow chart of reporting terminal information from the terminal device and resolving the terminal error according to an embodiment of the present invention.

### DETAILED DESCRIPTION OF THE EMBODIMENTS

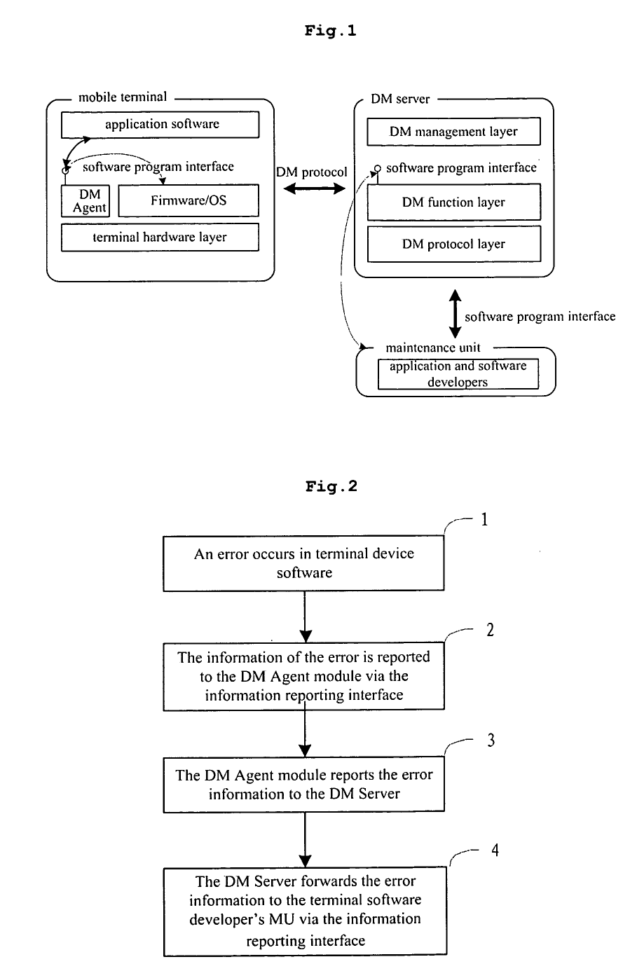

FIG. 1 is a schematic of the DM system architecture according to an embodiment of the present invention. Referring to FIG. 1, the DM system in an embodiment of the present invention includes DM Agent modules located in terminal devices, a DM Server, and a Maintenance Unit (MU).

The DM Agent module has a software program interface adapted for information reporting (hereinafter referred to as “information reporting interface”), which may be open to terminal Operation System (OS) and standard software on terminal OS as well as third-party software developers. The application software and firmware/OS of the terminal device reports terminal information to the DM Agent module via the information reporting interface.

The DM Agent module interacts with the DM Server via an OMA DM protocol interface.

Similarly, there is a standard information reporting interface at the DM Server side. The DM Server reports the received terminal information to the MU via the information reporting interface; the MU may be a maintenance unit deployed by the terminal software developer.

The terminal information includes error information created by the software of the terminal device, error information created by the hardware of the terminal device, and process information created during the operation of the terminal device. The reported process information may be utilized as a condition for triggering automatic resolution in case of any error of the terminal software, and may be used to provide debugging information during software development process, acquire software use information during the trial period, acquire information in its beneficial use, and provide a mechanism to timely feedback to end user in case of any error or abnormality of the software. The terminals include mobile terminals or fixed terminals.

Hereunder the implementation of the invention will be described in detail, assuming the terminal information as software error information.

Terminal error information is described in a XML format, which may be applied in the information reporting interface and the reporting protocol according to the present invention. The following table describes the relevant description tags that may be used in the error information description format for constituting complete error description information.

| Tag | Description |
|---|---|
| Report | Container tag of terminal information, adapted |
| | to contain a piece of terminal information |
| Info | Brief description of error |
| Level | Error Class |
| AppName | Application name |
| Provider | Application provider |
| Address | Entry address of automatic information |
| | reporting interface of the application provider |
| Version | Version of application software |
| DataType | Type of error data |
| Data | Error data |
| Date (Time) | Time |
| OS | Operating system |
| OSVersion | Version of operating system |
| MemorySize | Memory size |

The resulting XML format is as follows:

<Report>

<Info></Info>
<Level></Level>
<AppName></AppName>
<Provider></Provider>
<Address></Address>
<Version></Version>
<DataType></DataType>
<Data></Data>
<Date><Date>
<OS></OS>
<OSVersion></OSVersion>
<MemorySize></MemorySize>

</Report>

The above-mentioned information reporting interface includes a messaging interface, a file interface (or the exchanging of data by means of file handle provided in OS), an Application Programming Interface (API), or a Web service interface, etc, or any other appropriate interfaces. Wherein the messaging interface includes network protocol interface (e.g., TCP/IP interface, HTTP interface, UDP interface, or FTP interface) or an XML interface, etc.; the API is not limited to common local method invocation, but may also be used in remote method invocation by means of CORBA, Web Service (SOAP), RMI/IIOP, or DCOM, etc.

When the information reporting interface is API, the arguments of which may be in any of the following forms (only for reference, terminal information may be described in a more normalized and complete form when the standard is set down; there is no restriction in this aspect in the invention):

(1) Error Description Format

The system provides a Notify API for terminal software to report errors; the API is similar to:

void Notify (char info[ ]); The argument is in an XML format that conforms to the error description format.

<Report>

<Info>unknown error</Info>
<Level>1</Level>
<AppName>TestApp</AppName>
<Provider>Huawei</Provider>
<Address>http://support.huawei.com/dmtest/Notify</Address>
<Version>1.0.1</Version>
<DataType>text/plain</DataType>
<Data>report reason</Data>
<Date>20050428163030<Date>
<OS>linux</OS>
<OSVersion>1.1.1</OSVersion>
<MemorySize>16M</Memory Size>

</Report>

The approach is favorable for extending corresponding terminal error information; in the approach, the terminal software combines error information into the corresponding XML format.

(2) Pure API

The system provides a standard Notify for terminal software to report error information; the API is similar to:

void Notify (char name[ ], char provider[ ], char version[ ], char data[ ] . . . );

The contents of the arguments may be understood with reference to the relevant information in the error description format table. The approach is easy for use, but poor in extendibility.

When the DM Agent module reports the terminal error information through the information reporting interface, it reports the received software error information to the DM Server via an extended OMA DM protocol. The extended OMA DM protocol may be implemented in any of the following ways:

1. Implement with General Alert Command of the OMA DM Protocol:

The DM protocol supports events triggered by the client with General Alert command. The command may be extended to support the automatic reporting of terminal error information.

The extending of the information description may be made in either of the following ways (the fields used hereunder are only illustrative; terminal information may be described in a more normalized and completed format when the standard is set down; there is no restriction in this aspect in the invention):

A. Attaching Terminal Error Information Description in Data Field Directly:

<Alert>

<CmdID>1</CmdID>
<Data>1226</Data>
<Item>

<Source>

<LocURI>./SyncML/Sample</LocURI>

</Source>
<Meta>

<Type xmlns=”syncml:metinf”>
x-oma-application:syncml.samplealert
</Type>

<Format xmlns=”syncml:metinf”>xml</Format>
<Mark xmlns=”syncml:metinf”>critical</Mark>
</Meta>

<Data>//extended portion hereunder

<Report>

<Info></Info>
<Level></Level>
<AppName></AppName>
<Provider></Provider>
<Address></Address>
<Version></Version>
<DataType></DataType>
<Data></Data>
<Date><Date>
<OS></OS>
<OSVersion></OSVersion>
<MemorySize></MemorySize>

</Report>

</Data>

</Item>

</Alert>

By adding a tag such as <Report> tag to extend the Data tag, an automatic error reporting message may be transmitted. When the Server receives the message and finds the Report tag, it may determine that the General Alert is an error reporting message. And, the Server may retrieve response data and trigger a processing flow.

B. Attaching Terminal Error Information in the Form of Systematic [!CDATA] in Data Field:

<![CDATA[text content]]>
Attach description information in XML format in CDATA, for example:

<Data>

<![CDATA[

<Report>

<Info></Info>

<Level></Level>
<AppName></AppName>
<Provider></Provider>
<Address></Address>
<Version></Version>
<DataType></DataType>
<Data></Data>
<Date><Date>
<OS></OS>
<OSVersion></OSVersion>
<Memory Size></Memory Size>

</Report>

]]>

</Data>

(2) Implement by Adding New Commands

If the General Alert command is not used, the operation may be accomplished by extending special terminal information reporting commands (e.g., adding a Notify command). The Item tag may be used to contain the error information, the format of which may conform to the terminal information description format.

<Notify>

<CmdID>1</CmdID>
<Item>

<Report>

<Info></Info>
<Level></Level>
<AppName></AppName>
<Provider></Provider>
<Address></Address>
<Version></Version>
<DataType></DataType>
<Data></Data>
<Date><Date>
<OS></OS>
<OSVersion></OSVersion>
<MemorySize></MemorySize>

</Report>

</Item>

</Notify>

Detailed software information may be involved in the Item field of the Notify command, so as to assist the developer for debugging and handle them timely.

(3) Implement by Extending the Alert Command, Adding an Information Reporting Alert Command.

The standard Alert command for DM may be extended into a terminal information reporting Alert command. The terminal information reporting Alert command is allowed to have the same active reporting capability as the General Alert.

For example, the description field of the General Alert is described with <Data>1226</Data>. The Data field of the Alert command, for example, may be extended to 1227.

<Alert>

<CmdID>1</CmdID>
<Data>1227</Data>
...

</Alert>

The Alert command may be presented as Alert. The detailed information description format may be determined with reference to the error reporting format for terminal information reporting with the General Alert.

FIG. 2 is a flow chart of reporting terminal information from the terminal according to an embodiment of the present invention. Referring to FIG. 2, the automatic reporting process of terminal device software error is as follows:

Step 1: an error occurs in the terminal device software; and the information of the error is described in the XML format;

Step 2: the terminal software reports the error information to the DM Agent module through the standard information reporting interface;

Step 3: the DM Agent module reports the error information to the DM Server via the extended OMA DM protocol;

Step 4: the DM Server forwards the error information to the MU of the terminal software developer through the information reporting interface, so that the MU may perform recording and statistics for software errors. Before reporting the error information, the DM Server may perform addition or deletion on data and format conversion for the error information (e.g., filtering off the user's mobile telephone number and transmitting to the MU).

The DM system may maintain a list of applications and the corresponding MU addresses (or ISP addresses), so that the DM Server may obtain the MU address (ISP address) from the list according to the application indicated in the terminal information. For example, the addresses list may be stored in the DM Server locally.

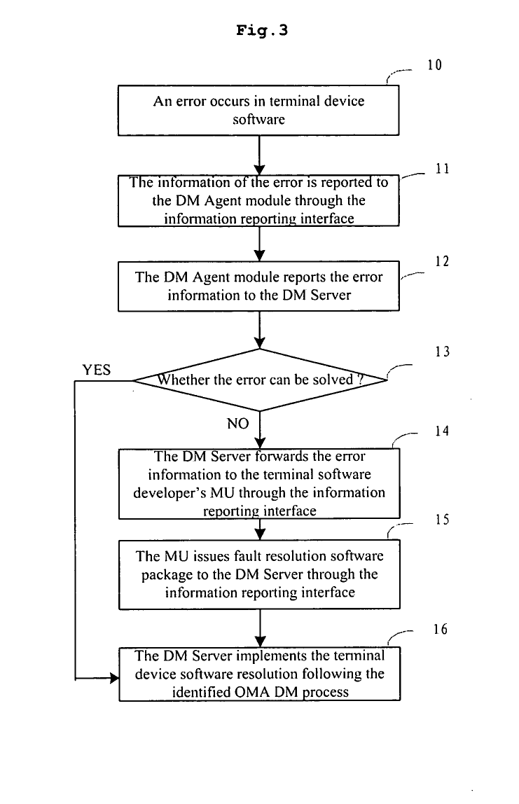

FIG. 3 is a flow chart of reporting terminal information from the terminal device and resolving the terminal device error according to an embodiment of the present invention. Referring to FIG. 3. The automatic process of terminal device error reporting and handling is as follows:

Step 10: an error occurs in the terminal device software; and the information of the error is described in the XML format;

Step 11: the terminal software reports the error information to the DM Agent module through the standard information reporting interface;

Step 12: the DM Agent module reports the error information to the DM Server via the extended OMA DM protocol;

Step 13: the DM Server searches the local maintenance database to see whether there is corresponding solution information according to the application information indicated in the error information; if there is a matched solution, the DM Server determines the error may be solved automatically, and the flow proceeds to Step 16; otherwise the flow proceeds to Step 14;

Step 14: the DM Server reports the error information to the terminal software provider's MU through the standard information reporting interface;

Step 15: the terminal software developer analyzes the error, provides a software package to solve the error, and issues the software package to the DM Server through the information reporting interface;

Step 16: the DM Server implements the terminal software resolution following the standard OMA DM process.

An embodiment of the terminal device error information reporting and the terminal maintaining is shown as follows:

Suppose the terminal information reported from the ME of user A is:

<Report>

<Info>Version Error</Info>
<Level>High</Level>
<AppName>TestApp</AppName>
<Provider>Huawei</Provider>
<Address>www.huawei.com</Address>
<Version>1.0.1</Version>
<DataType>text/plain</DataType>
<Data>8001</Data>
<Date>20050505201010<Date>
<OS>MobileOS</OS>
<OSVersion>1.0.2</OSVersion>
<MemorySize>200</MemorySize>

</Report>

The terminal information indicates an error coded as 8001 occurs in the program with the application named as TestApp and the version number as 1.0.1.

Suppose the automatic processing information for the local error handling is maintained in the DM Server:

| | Version | Error | Processing | |
|---|---|---|---|---|
| AppName | Number | Data | Mode | Data |
| TestApp | 1.0.1 | 8001 | 01(here “01” | /root/update/testapp/ |
| | | | indicates new | 1.0.2/update.dat |
| | | | version update) | |
| . . . | . . . | . . . | . . . | . . . |

After checking the reported error information, the DM Server searches the table for matching; if finding the corresponding processing data there, the DM Server will update the terminal software according to the processing mode and the corresponding data therein, so as to attain the result of automatic error handling. If the processing information is not found, the DM Server will report the terminal information to the MU (or ASP).

In the flow shown in FIG. 3, the DM Server may also be configured not to handle the error but report the error information directly to the terminal software developer's MU for handling.

As for the hardware error information and process information created by terminal devices, the handling procedures are identical to those for the above error information, except for the tag in the description format, which is slightly different to the tag for the above error information.

The embodiments mentioned above are only used to describe and explain the principle of the invention. It is understood that the embodiments of the invention are not limited to those ones. Those skilled in the art may easily make modifications and alterations, without departing from the spirit and scope of the invention; however, any of such alterations or modifications shall fall into the protected domain of the invention. Therefore, the protected domain of the invention shall only be confined by the claims.

1. A method of reporting terminal information, comprising the following steps:
reporting, by a terminal device, terminal information through a software program interface provided by a Device Management (DM) Agent module;
forwarding, by said DM Agent module, said terminal information to a DM Server; and
reporting, by said DM Server, said terminal information to a Maintenance Unit (MU).

2. The method as in claim 1, wherein said software program interface comprises a messaging interface, a file interface, an API, or a Web service interface.

3. The method as in claim 2, wherein said messaging interface comprises an XML interface or a network protocol interface.

4. The method as in claim 2, wherein when said software program interface employs the API, the terminal information is combined into an XML format and is transmitted to the API as an argument.

5. The method as in claim 1, wherein said DM Agent module transmits said terminal information via an extended Open Mobile Alliance DM (OMA DM) protocol.

6. The method as in claim 5, wherein the transmission of said terminal information by said DM Agent module is implemented:
with a command of the extend OMA DM protocol which supports active event triggered by clients; or
by said DM Agent module is implemented by extending a standard command of the OMA DM protocol into a terminal information reporting command; or
by adding a special terminal information reporting command into the OMA DM protocol; or
with a command of the OMA DM protocol directly.

7. The method as in claim 1, wherein said terminal information comprises error information created during the operation of the terminal software, error information created by the terminal hardware, and process information created during the operation of the terminal.

8. A method for maintaining terminal device, comprising the following steps:
reporting, by a terminal device, terminal information through a software program interface provided by a Device Management (DM) Agent module;
forwarding, by said DM Agent module, said terminal information to a DM Server;
reporting, by said DM Server, said terminal information to a Maintenance Unit (MU);
upon receiving said terminal information, determining, by said MU, the corresponding software update package and sending said software update package to the DM Server;
maintaining, by said DM Server, the terminal device with said software update package following an OMA DM process.

9. The method as in claim 8, before the step of reporting by said DM Server said terminal information to a Maintenance Unit (MU), said method further comprising:
upon receiving said terminal information, judging, by said DM Server, whether the terminal device can be maintained automatically;
if the judgment is “Yes”, maintaining, by said DM Server, the terminal device directly following the OMA DM process;
otherwise the method proceeds to the step of reporting by said DM Server said terminal information to a Maintenance Unit (MU) and the subsequent steps of the reporting step.

10. The method as in claim 8, wherein said software program interface comprises a network protocol interface, an XML interface, or an API.

11. The method as in claim 10, wherein when said software program interface employs the API, terminal device program will combine the terminal information into an XML format and send the combined terminal information to the API as an argument.

12. The method as in claim 8, wherein said DM Agent module transmits said terminal information via an extended OMA DM protocol.

13. The method as in claim 12, wherein the transmission of said terminal information by said DM Agent module is implemented:
with commands supporting active event triggered by clients in the extend OMA DM protocol; or
by extending a standard command of OMA DM protocol into a terminal information reporting command; or
by adding a special terminal information reporting command into the OMA DM protocol;
or with a command of the OMA DM protocol directly.

14. The method as in claim 8, wherein said terminal information comprises error information created during operation of the terminal software, error information created by terminal hardware, and process information created during operation of the terminal.

15. A Device Management (DM) system, comprising a DM Server adapted to manage a terminal device, a DM Agent module located in the terminal device and interacting with said DM Server; said Device Management system further comprising a Maintenance Unit (MU) coupled to said DM Server and adapted to acquire, store, and maintain the information of the terminal device;
said DM Agent modules and said DM Server have a software program interface respectively;
the software program interface of said DM Agent module is adapted to receive the terminal information reported from the terminal device and forward the terminal information to the DM Server; said DM Server reports said terminal information to said MU.

16. The DM system as in claim 15, wherein said software program interface comprises a messaging interface, a file interface, an API, or a Web service interface.

17. A system for reporting terminal information applied to a communication network, the system comprising:
a first terminal configured to communicate with a second terminal accessing said communication network;
a management unit arranged in said first terminal, configured to receive the information of said first terminal reported by said first terminal; and
a management server, configured to receive the information sent by said management unit.

18. The system as in claim 17, wherein the information of said first terminal is reported to said management unit via a software program interface; said software program interface comprises a messaging interface, a file interface, an API, or a Web service interface.

19. The system as in claim 18, wherein said messaging interface comprises an XML interface or a network protocol interface.

20. The system as in claim 18, wherein when said software program interface employs said API, the information of the said first terminal is combined into an XML format and is reported to said API as an argument.

21. The system as in claim 17, wherein said management unit sends the information of said first terminal to said management server via an extended Open Mobile Alliance DM (OMA DM) protocol.

22. The system as in claim 21, wherein said management unit sends the information of said first terminal to said management server:
with a command of said extend OMA DM protocol which supports active event triggered by clients; or
by extending a standard command of said OMA DM protocol into a terminal information reporting command; or
by adding a special terminal information reporting command into said OMA DM protocol; or
with a command of said OMA DM protocol directly.

23. A system for maintaining terminal device applied to a communication network, the system comprising:
a first terminal configured to communicate with a second terminal accessing said communication network;
a management unit arranged in said first terminal, configured to receive the error information of said first terminal;
a management server, configured to receive the error information sent by said management unit; and
a maintenance unit, configured to receive the error information of said first terminal sent by said management server and send a corresponding software update package for maintaining said first terminal to said management server.

24. The system as in claim 23, wherein said management server maintains said first terminal with said corresponding software update package following an OMA DM process.

25. The system as in claim 23, wherein upon receiving the error information of said first terminal, said management server judges whether said first terminal can be maintained automatically; if said judgment is “Yes”, said management server maintains said first terminal directly following said OMA DM process; otherwise, said management server sends the error information of said first terminal to said maintenance unit.

26. A method of reporting terminal information applied to a communication network, the method comprising:
reporting, by a terminal accessing said communication network, the information of the terminal to a management unit;
upon receiving the information of the terminal, the management unit sending the information to a management server.

27. The method as in claim 26, wherein the information of said terminal is reported to said management unit via a software program interface; said software program interface comprises a messaging interface, a file interface, an API, or a Web service interface.

28. The method as in claim 27, wherein said messaging interface comprises an XML interface or a network protocol interface.

29. The method as in claim 27, wherein when said software program interface employs said API, said terminal information is combined into an XML format and is reported to said API as an argument.

30. The method as in claim 26, wherein said management unit sends the information of said terminal to said management server via an extended Open Mobile Alliance DM (OMA DM) protocol.

31. The method as in claim 30, wherein said management unit sends the information of said terminal to said management server:
with a command of said extend OMA DM protocol which supports active event triggered by clients; or
by extending a standard command of said OMA DM protocol into a terminal information reporting command; or
by adding a special terminal information reporting command into said OMA DM protocol; or
with a command of said OMA DM protocol directly.

32. A method for maintaining terminal device applied to a communication network, the method comprising:
sending, by a terminal accessing said communication network, the information of the terminal to a management unit;
upon receiving the information of the terminal, the management unit sending the information to a management server;
upon receiving the information of the terminal, said management server a corresponding software update package for maintaining said first terminal to said management server.

33. The method as in claim 32, wherein said management server maintains said terminal with said corresponding software update package following an OMA DM process.

34. The method as in claim 32, wherein upon receiving the error information of said first terminal, said management server judges whether said first terminal can be maintained automatically; if said judgment is “Yes”, said management server maintains said first terminal directly following said OMA DM process; otherwise, said management server reports the error information of said first terminal to said maintenance unit.
